(19) United States
(12) Patent Application Publication
(10) Pub. No.: US 2023/0015584 A1
(43) Pub. Date: Jan. 19, 2023

(54) INSTRUMENTS INCLUDING AN ELECTRON MULTIPLIER

(71) Applicant: ADAPTAS SOLUTIONS PTY LTD, CLYDE, NEW SOUTH WALES (AU)

(72) Inventor: Russell Jurek, Clyde, New South Wales (AU)

(21) Appl. No.: 17/783,480

(22) PCT Filed: Dec. 7, 2020
(86) PCT No.: PCT/AU2020/051334

§ 371 Date: Jun. 8, 2022

(30) Foreign Application Priority Data
Dec. 9, 2019 (AU) 2019904658

(51) Int. Cl. H01J 43/22; H01J 43/30; H01J 49/02; H01J 49/40

(52) U.S. Cl. CPC H01J 43/22; H01J 43/30; H01J 49/025; H01J 49/022; H01J 49/40

(57) ABSTRACT

Scientific instruments (such as mass spectrometers) include an electron multiplier and a cross-filed ion detector including an ion impact plate. The electron multiplier receives and amplifies secondary electrons emitted by the impact plate to generate an output signal. The output signal is amplified and subsequently digitized. Amplification is limited so as to keep secondary electrons to a maximum thereby decreasing electron flux and improving instrument life.

### FIELD OF THE INVENTION

The present invention relates generally to scientific instruments comprising an electron multiplier, and methods for operating same. An exemplary instrument in the context of the invention is a mass spectrometer.

### BACKGROUND TO THE INVENTION

In a mass spectrometer, the analyte is ionized to form a range of charged particles (ions). The resultant ions are then separated according to their mass-to-charge ratio, typically by acceleration and exposure to an electric or magnetic field. The separated signal ions are caused to enter a detector. The detector normally comprises some means for amplifying the ion signal. The amplification means may rely on the principle of secondary electron emission whereby the impact of a single particle on a suitable surface result in the emission of multiple secondary electrons therefrom. Such amplification means are typically referred to as a secondary electron multiplier.

There are two basic forms of electron multipliers that are commonly used in mass spectrometry: the discrete-dynode electron multiplier and the continuous-dynode electron multiplier.

A typical discrete-dynode electron multiplier has between 12 and 24 dynodes. Each dynode has a secondary electron yield of >1, such that the incoming signal is amplified in a step-wise manner by each subsequent dynode.

A continuous-dynode electron multiplier (often referred to as a channel electron multiplier, CEM, or channeltron) is constructed differently, in that the individual dynodes are replaced by a tube, and electrons bounce along the tube towards a terminus and the signal amplifying along the way.

Whatever the means of amplification, the amplified electron signal impacts on a terminal anode which outputs an electrical signal proportional to the number of electrons which impact it. The signal from the anode is conveyed to a computer where it is displayed as a mass spectrum of the relative abundance of detected ions as a function of the mass-to-charge ratio.

Spectra output in mass spectrometry are used to determine the elemental or isotopic signature of a sample, the masses of particles and of molecules, and to elucidate the chemical structures of molecules and other chemical compounds.

A problem in the art is that electron emissive elements in the electron multiplication means of a detector degrade over time due at least in part to the high voltages required for operation. Some prior artisans consider the degradation to be the result of alterations in the surface coating of electron emissive elements due to contact with electron avalanches, which in turn increases the work function of the surfaces to thereby cause a reduction in secondary electron yield. This has been found by the Applicant to be incorrect. The electron emissive surfaces of a detector are not modified, but instead become buried under layers of carbon compounds which become chemically bonded to the surfaces by electron impact. The need for electrons to “punch” through this additional material is what causes the work function to increase.

Detector degradation is a problem of cross-field detectors such as time-of-flight detectors (such as the MagneTOF™ detectors of Adaptas Solutions), and detectors having channel electron multiplication means. For example, a new MagneTOF™ detector may operate at a voltage of around 2500 V, however when aged may require higher operating voltages around 4000 V. Eventually, the use of high voltages brings the service life of the detector to an end, and a new detector must be purchased.

While the prior art provides various means by which the service life of a detector may be improved, in implementing such means the ability of the detector to respond to low signals is compromised or lost. For example, a detector having an improved service life may also have a lower signal-to-noise ratio leading to a significant reduction in sensitivity.

It is an aspect of the present invention to provide an improvement to ion detector apparatuses so as to extend the service life of the electron amplification component(s), without a substantial negative impact on the ability to detect very low electron signals. It is a further aspect of the present invention to provide a useful alternative to prior art detector apparatus.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In one aspect, but not necessarily the broadest aspect, the present invention provides an apparatus for detecting a particle (such as an ion), the apparatus comprising a particle detector comprising: particle conversion means configured to convert a incoming ion into one or more secondary electrons upon impact thereon, secondary electron amplification means configured to receive and amplify the one or more secondary electrons emitted by the particle conversion means and output an output signal, an amplifier configured to receive and amplify the output signal of the cross-field detector, and digitizing means configured to receive and digitize the output of the amplifier, wherein the particle detector is a cross-field detector that is operable so as to limit the amplification of an incoming particle to secondary electrons to a maximum of about 10⁷, 10⁶, 10⁵, or 10⁴ secondary electrons per incoming particle.

In one embodiment of the first aspect, the particle conversion means and the secondary electron amplification means are an integral unit.

In one embodiment of the first aspect, the cross-field detector is a time-of-flight detector and the particle conversion means is an ion impact plate.

In one embodiment of the first aspect, the time-of-flight detector is configured to provide a pulse width of less than about 2 ns, 1.5 ns, 1 ns, 0.9 ns, 0.8 ns, 0.7 ns, 0.6 ns, 0.5 ns or 0.4 ns FWHM (full width half maximum).

In one embodiment of the first aspect, the time-of-flight detector is configured to provide a highly uniform electrostatic field in the area extending from a detector input aperture through which an incoming particle is received to the ion impact plate.

In one embodiment of the first aspect, the highly uniform electrostatic field is provided at least in part by paired grids, each grid having a plain orthogonal to the ion impact plate, each grid fabricated from parallel conducting wires.

In one embodiment of the first aspect, the highly uniform electrostatic field is provided at least in part by a ledge extending away from the ion impact plate, the ledge being at an edge of the ion impact plate over which secondary electrons emitted by the ion impact plate travel.

In one embodiment of the first aspect, the highly uniform electrostatic field is configured to reduce jitter in arrival times of particles transiting through the area extending from the detector entrance through which an incoming particle is received on the ion impact plate.

In one embodiment of the first aspect, the ion impact plate has a flatness controlled to within ±10 μm, or within ±5 μm.

In one embodiment of the first aspect, the ion impact plate is fabricated from approximately 3 mm thickness stainless steel coated in a dynode material.

In one embodiment of the first aspect, the apparatus comprising one or more compensation apertures about the edge of the highly uniform electrostatic field to compensate for edge effects arising from field penetration through one or both of the paired

In one embodiment of the first aspect, the time-of-flight detector is configured to provide a non-uniform magnetic field which functions to guide electrons emitted from the particle conversion means toward the electron multiplication means.

In one embodiment of the first aspect, the time-of-flight detector is a MagneTOF™ detector or a functional equivalent thereof, including model DM291 and model DM167, or a functional equivalent thereof.

In one embodiment of the first aspect, the cross-field detector is, or comprises, a channel electron multiplier.

In one embodiment of the first aspect, the cross-field detector is operable so as to limit the amplification of an incoming particle to a maximum of about 10³, 10², or 10¹.

In one embodiment of the first aspect, the cross-field detector is operable so as to limit the amplification of an incoming particle to a maximum of about five-fold.

In one embodiment of the first aspect, the amplification of the cross-field detector is settable by an operating voltage thereof.

In one embodiment of the first aspect, the operating voltage is settable so as to prevent or inhibit the generation of a carbonaceous layer on a secondary electron emitting surface of the particle conversion means and/or the secondary electron amplification means.

In one embodiment of the first aspect, the cross-field detector has an output and the amplifier has an input, and the amplifier input is disposed proximal to the cross-field detector output.

In one embodiment of the first aspect, the amplifier input is disposed at a maximum of about 100 cm, 90 cm, 80 cm, 70 cm, 60 cm, 50 cm, 40 cm, 30 cm, 20 cm or 10 cm from the cross-field detector output.

In a second aspect, the present invention provides a method for detecting a particle, the method comprising: providing a particle detector comprising: particle conversion means configured to convert a incoming ion into one or more secondary electrons upon impact thereon, secondary electron amplification means configured to receive and amplify the one or more secondary electrons emitted by the particle conversion means and output an output signal, providing an amplifier configured to receive and amplify the output signal of the cross-field detector, and providing digitizing means configured to receive and digitize the output of the amplifier, wherein the particle detector is a cross-field detector that is operated so as to limit the amplification of an incoming particle to secondary electrons to a maximum of about 10⁷, 10⁶, 10⁵, or 10⁴ secondary electrons per incoming particle.

In one embodiment of the second aspect, the particle conversion means and the secondary electron amplification means are an integral unit.

In one embodiment of the second aspect, the cross-field detector is a time-of-flight detector and the particle conversion means is an ion impact plate.

In one embodiment of the second aspect, the time-of-flight detector is configured to provide a pulse width of less than about 2 ns, 1.5 ns, 1 ns, 0.9 ns, 0.8 ns, 0.7 ns, 0.6 ns, 0.5 ns or 0.4 ns FWHM (full width half maximum).

In one embodiment of the second aspect, the time-of-flight detector is configured to provide a highly uniform electrostatic field in the area extending from the detector input aperture through which an incoming particle is received to the particle conversion means.

In one embodiment of the second aspect, the highly uniform electrostatic field is provided at least in part by paired grids, each grind having a plain orthogonal to the ion impact plate, each grid fabricated from parallel conducting wires.

In one embodiment of the second aspect, the highly uniform electrostatic field is provided at least in part by a ledge extending away from the ion impact plate, the ledge being at an edge of the ion impact plate over which secondary electrons emitted by the ion impact plate travel.

In one embodiment of the second aspect, the highly uniform electrostatic field is configured to reduce jitter in arrival times of particles transiting through the area extending from the detector entrance through which an incoming particle is received to the ion impact plate.

In one embodiment of the second aspect, the ion impact plate has a flatness controlled to within ±10 μm, or within ±5 μm.

In one embodiment of the second aspect, the ion impact plate is fabricated from approximately 3 mm thickness stainless steel coated in a dynode material.

In one embodiment of the second aspect, the method comprises one or more compensation apertures about the edge of the highly uniform electrostatic field to compensate for edge effects arising from field penetration through one or both of the paired grids.

In one embodiment of the second aspect, the time-of-flight detector is configured to provide a non-uniform magnetic field which functions to guide electrons emitted from the particle conversion means toward the electron multiplication means.

In one embodiment of the second aspect, the time-of-flight detector is a MagneTOF™ detector or a functional equivalent thereof, including model DM291 and model DM167.

In one embodiment of the second aspect, the cross-field detector is, or comprises, a channel electron multiplier.

In one embodiment of the second aspect, the cross-field detector is operated so as to limit the amplification of an incoming particle to a maximum of about 10³, 10², or 10¹.

In one embodiment of the second aspect, the cross-field detector is operated so as to limit the amplification of an incoming particle to a maximum of about five-fold.

In one embodiment of the second aspect, the amplification of the cross-field detector is set by an operating voltage thereof.

In one embodiment of the second aspect, the operating voltage is set so as to prevent or inhibit the generation of a carbonaceous layer on a secondary electron emitting surface of the particle conversion means and/or the secondary electron amplification means.

In one embodiment of the second aspect, the cross-field detector has an output and the amplifier has an input, and the amplifier input is disposed proximal to the cross-field detector output.

In one embodiment of the second aspect, the amplifier input is disposed at a maximum of about 100 cm, 90 cm, 80 cm, 70 cm, 60 cm, 50 cm, 40 cm, 30 cm, 20 cm or 10 cm from the cross-field detector output.

### BRIEF DESCRIPTION OF THE DRAWINGS

FIG. 1 illustrates highly diagrammatically a preferred embodiment of the invention as applied to a mass spectrometer. In this embodiment, the amplifier is disposed within the vacuum chamber of the spectrometer.

FIG. 2 illustrates highly diagrammatically a preferred embodiment of the invention as applied to a mass spectrometer. In this embodiment, the amplifier is disposed outside the vacuum chamber of the spectrometer.

FIG. 3 illustrates structural features and electron optics of a MagneTOF™ detector that may be used as a time-of-flight detector in the context of the present invention.

### DETAILED DESCRIPTION OF THE INVENTION AND PREFERRED EMBODIMENTS THEREOF

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments, or indeed any embodiment covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

The present invention is predicated at least in part on the discovery that the service life of a cross-field detector (and particularly a MagneTOF™ detector) is improved when operated at a lower than normal voltage by using an electron signal amplifier proximally positioned at the output of the electron multiplication means of the detector. Without wishing to be limited by theory in any way, it is proposed that service life is improved by lowering the operating voltage so as to prevent or inhibit the build up and chemical bonding of carbon-based compounds on the electron emissive surfaces of the electron multiplier component of the detector. A negative result of lowering operating voltage is that amplifier gain is reduced and electron signal caused by a low detector input signal (such as a single ion) may be lost against the background noise inherent in the detector system. This loss in signal against the background noise may be addressed by the introduction of a signal amplifier (such as a pre-amplifier) proximal to the output of the electron multiplication means of the detector. This avoids the need for an unamplified signal to travel along an electrical conduit to the exterior of the instrument concerned (such as a mass spectrometer) thereby limiting the opportunity for the signal to be lost against the noise which inevitably accumulates in the conduit with increasing length.

It is proposed that the present invention is particularly applicable to detectors using a cross-field electron multiplier. Cross-field electron multipliers derive their name from their use of orthogonal electric and magnetic fields, that are referred to as ‘crossed fields’. Implementing a cross-field electron multiplier may require incorporating elements of both discrete-dynode and continuous-dynode electron multiplier implementations. This typically extends even to individual elements/electrodes of a cross-field electron multiplier. Implementing a cross-field electron multiplier may require individual elements/electrodes to share properties, features, characteristics and implementations with both discrete and continuous dynodes. As such, cross-field electron multipliers are a separate type of electron multiplier. While they may borrow elements from discrete-dynode and continuous-dynode electron multipliers, cross-field electron multipliers are not an examples of, discrete-dynode and continuous-dynode electron multipliers.

The operating voltage of the detector is selected so as to limit the ability for carbon compounds to chemically bond with the surface of an electron emissive surface of the detector. The voltage may be safely lowered with loss of signal given the presence of an amplifier after the electron multiplier. In one regard, this limits the numbers of electrons output by the electron amplification means of the detector. In this way, an electron emissive surface is exposed to lower electron flux thereby lessening the amount of carbonaceous material that deposits on and binds to the surface. For example, the detector may be operated under conditions such that the number of electrons output for each ion input is less than about 10⁸, or 10⁷, or 10⁶, or 10⁵, or 10⁴, or 10³, or 10². In another regard, this may be achieved by lowering the operating voltage so as to limit the chemical bonding cross-section (i.e. probability) of electrons incident upon emissive surfaces. For a given electron flux and given density of carbonaceous compounds, this will slow the rate of chemical bonding, thereby improving detector life. For example, the detector may be operated under conditions such that the impact energy of electrons incident the emissive surfaces, is reduced by more than about 5%, 10%, 15%, 20%, 25%, 30%, 40%, 50%, 60%, 70%, 80%, 90%, 95%

Suitable conditions for operation may be decided by exposing the electron emissive material concerned to various levels of electron impingement and detecting the levels of carbonaceous material chemically bonding to the surface of the electron emissive material. For example, the surface may be washed with a weak base or a detergent so as to remove non-bonded material therefrom. The washed surface may then be chemically treated to interrupt the bonds between surface and the carbon compounds, for example using a strong acid, base, or with a catalyst or an enzyme and the released compounds assayed for amount. Alternatively, the washed surface may be subjected to electron microscopy so as to assess the depth of any carbonaceous layer on the surface. In any event, the amount/depth of bonded carbon material can be correlated with operating conditions allowing for the selection of conditions favouring lower deposition and therefore an improvement in service life.

Once the operating conditions have been set to favour service life, the level of amplification of the electron amplifier output may be assessed. As discussed above, for an improvement in service life, a low electron current is preferred. Amplifying the lower output current proximal to the output allows for a signal having a relatively high signal-to-noise ratio to be sent from the detector in amplified form to an external computer for analysis in the usual manner. Given the benefit of the present specification, the level of amplification required in order to have an acceptable signal-to-noise ratio at the computer input may be assessed empirically.

In some embodiments, the level of amplification may be at least 2-fold, 3-fold, 4-fold, 5-fold, 6-fold, 7-fold, 8-fold, 9-fold, 10-fold, 11-fold, 12-fold, 13-fold, 14 fold, 15-fold, 16-fold, 17-fold, 18-fold, 19-fold, 20-fold, 21-fold, 22-fold, 23-fold, 24-fold, or 25-fold. Preferably, the amplification is between about 2-fold to about 8-fold, or between about 4-fold to about 6-fold.

As will be appreciated, an amplifier will add noise to the signal, with the level of noise typically in accordance with the level of amplification. Accordingly, a low noise amplifier is preferably used, and the level of amplification selected so as to maintain an acceptable signal-to-noise ratio at the input of the signal analysing computer. Noise may be lowered also by cooling the amplifier, which may be achieved using a Peltier effect device. As a further strategy, noise may be lowered by shielding proximal components (such as transformers) using conductive or magnetic shields such as metal sheet, metal screen or metal foam.

The amplifier may be positioned within 1 cm, 2 cm, 3 cm, 4 cm, 5 cm, 6 cm, 7 cm, 8 cm, 9 cm, 10 cm, 11 cm, 12 cm, 13 cm, 14 cm, 15 cm, 16 cm, 17 cm, 18 cm, 19 cm, 20 cm, 21 cm, 22, cm, 23, cm, 24, cm, 25 cm, 26 cm, 27 cm, 28 cm, 29 cm, 30 cm, 31 cm, 32 cm, 33 cm, 34 cm, 35 cm, 36 cm, 37 cm, 38 cm, 39 cm, 40 cm, 41 cm, 42 cm, 43 cm, 44 cm, 45 cm, 46 cm, 47 cm, 48 cm, 49 cm or 50 cm from the output of the electron amplification means, and preferably connected with the shortest possible length of conduit.

A relatively high signal-to-noise ratio will be found where the amplifier is disposed within the vacuum chamber, such a position providing for very close proximity between the output of the electron amplification means of the detector and the output signal amplifier.

The amplifier is preferably selected so as to faithfully amplify the pulse currents arising from the secondary electron avalanche, and without any distortion. Furthermore, the selection of amplifier should take into account the background noise that would be generated when a sufficient level of amplification is used. Generally, sufficient amplification of about 5-fold to about 10-fold provides a reasonable compromise between amplification level and noise. In terms of operation, a 5-fold to 10-fold amplification may allow for the electron multiplier to be operated at a gain of 10-fold to 100-fold lower than that normally used. For example, the electron multiplier may be operated at a lower than normal voltage such that a gain of only 10³, 10⁴, or 10⁵ is used, with such gains requiring significantly reduced operational voltages and significantly reduced electron fluxes thereby increasing service life of the detector.

As useful amplifier may be a fast amplifier with a small signal bandwidth such as 2.4 GHz and/or a full power bandwidth of 875 MHz. Input referred noise may be 2.8 nV/SQUARE_ROOT(Hz) or 3.2 μVRms Noise figure (100 MHz) may be 16 dB.

A high speed amplifier may feature DC coupling to avoids count rate effects due to non-DC balanced pulse trains and the corresponding charging of coupling capacitors. The amplifier may be of a non-inverting, closed loop, voltage mode, operational amplifier design. Input offset adjustment may be provided.

Cooling of the amplifier when disposed in an evacuated environment becomes problematic. For example, where a thermo-electric cooling device (such as those based on the Peltier effect) may be used. Such devices are solid state and virtually maintenance free. Multiple devices may be stacked according the amount of thermal energy that must be removed from the amplifier. To optimally function heat is preferably be removed from the heat dissipating side of the thermo-electric device. However the substantial absence of air in the vacuum chamber prevents any use of any convective method to cool the heat dissipating side of the thermos-electric device. As an alternative to air cooling, a conductive means may be used, such means comprising a thermally conductive body in thermal contact with the heat dissipating side of the thermos-electric device, the conductive body passing through the vacuum chamber wall (whilst maintaining the vacuum tightness of the chamber) and outside the chamber where a convective of other cooling means may be used to draw heat from the conductive body (and in turn the thermoelectric device).

Alternatively, the conductive body or the thermo-electric device itself may contact the inner wall of the vacuum chamber, the wall acting itself as a heat sink. The outer wall of the chamber may be air cooled, or cooled with a water jacket for example if required to sufficiently cool the amplifier.

In one embodiment, the invention is embodied in a cross-field detector capable of spatially focussing electrons resulting from the impact of the particles to be detected, without degradation of an ion impact timing information. Such detectors may be reliant on one, two, three or four mechanisms for achieving the aforementioned objective. Each mechanism takes advantage of the secondary electrons that result from the impact of electrons or ions against a surface. Each mechanism involves deflection of electrons by an electrostatic field in conjunction with a magnetic field preferably generally orthogonal or nearly orthogonal to the electrostatic field, as distinct from deflection by electrostatic field only. Such detectors furthermore do not generally rely on an external ion conversion plate, but instead have an integral surface configured to emit secondary electrons upon impact with an ion. In that regard, the ions may be considered to impact an integral dynode of the detector. The secondary electrons (still within the detector) are then compelled to travel along field lines to the signal multiplication dynode(s) of the detector.

In the combined magnetic and electrostatic field arrangements of the preferred detector, the low energy secondary electrons will preferably follow a circular, near circular, elliptical, near elliptical, cycloidal or near cycloidal trajectory path in such a combination of fields. The distance the electron travels along a surface (x) in these trajectories (and the radius of curvature) will be proportional to the electrostatic field strength (E) divided by the square of the magnetic field strength (B): x=K*E/B² (K=a constant). Therefore, this E/B² ratio is a convenient way of defining the detector's operational parameters.

The first mechanism involves deflection of the electrons from one dynode to another in a combined field where the E/B² ratio is decreased from the electron emitting dynode to the next target dynode. The target dynode may be the input of the amplifying section. The second mechanism involves deflection of electrons through an angle greater than 180 degrees in a combined field with either a uniform or non-uniform E/B² ratio. This latter technique has optimal time coherence for deflections at or near 180 degrees, at or near 270 degrees, or at or near 360 degrees (and larger multiples of 90 degrees) and has greatest magnification or focussing capability at or near 270 degrees. The third mechanism involves deflection of electrons in a combined field with either a uniform or non-uniform E/B² ratio along the axis of net electron migration. A magnetic field which is uniform and strictly orthogonal to the electrostatic field will result in no electron focussing in a dimension parallel to the nominal magnetic field direction. In the third mechanism, an appropriate shape of the magnetic field results in variations from a field that is strictly orthogonal to the electrostatic field which further results in focussing the electrons in a second dimension (the dimension which is generally parallel to the nominal magnetic field direction). In the fourth mechanism, electrons are confined within a pair of electric potentials (voltages). This provides an ability to guide electrons along complicated trajectories. Additionally, the cross-sectional area of the electron flux trapped within the pair of electric potentials can be modified as required. This provides another mechanism for mapping a large electron emission region e.g. ion impact surface, to a small target region e.g. start of continuous amplification dynode.

Reference has been made supra to focussing of the electron trajectories in the x and y directions. Focussing in the z direction may be also obtained by magnetic pole pairs to centralise or focus the “beam” of electron trajectories in the z direction. Secondly, the positioning of the upper edges of pole pieces near the level of an entrance grid is found to generate an advantageous edge effect that focuses, in the z direction. These edge effects cause a curvature of the magnetic field, which deflects the electrons towards the centre of the detector in the z direction.

In some embodiments, the electron amplification within the detector is provided by discrete dynodes, while in others a continuous dynode is used.

With regard to the detector, the detector may comprise: cathode means defining an impact surface on which particles impact, which surface has a finite probability of generating at least one electron for each impacting particle having predetermined characteristics; a plurality of electron multiplication dynode segments, including a first dynode segment, arranged in an array; and respective means for generating electrostatic and magnetic fields in a space extending from said impact surface past said dynode segments, whereby said electrons cascade and multiply successively along said array of dynode segments; wherein said means for generating said magnetic and electrostatic fields are configured whereby the E/B² ratio adjacent any of said dynode segments is smaller than adjacent the preceding dynode segment or impact surface relative to the direction of the cascade, whereby to decrease the radius of curvature of the electron trajectories along said cascade and to thereby focus the electron trajectories in at least one dimension, preferably in at least two dimensions; the detector or detector system further comprising an amplifier in operable communication with and proximal to the signal output of the array of dynode segments.

Preferably, the E/B² ratio is progressively decreased from the first dynode segment or impact surface to the next dynode. In one embodiment, the decrease is confined to the region from the impact surface to the first dynode segment or to the amplifying section. In another embodiment, there is alternatively or additionally a progressive decrease in the E/B² ratio along the dynode array.

The detector may comprise cathode means defining an impact surface on which particles impact, which surface has a finite probability of generating at least one electron for each impacting particle having predetermined characteristics; an electron receiving element; and respective means for generating electrostatic and magnetic fields in a space extending from said impact surface to said electron receiving element; wherein said means for generating said electrostatic and magnetic fields are configured whereby the E/B² ratio adjacent said electron receiving element segment is smaller than adjacent the impact surface, whereby to decrease the radius of curvature of the electron trajectories adjacent the electron receiving element relative to adjacent the impact surface and to thereby focus the electron trajectories in at least one dimension, preferably in at least two dimensions, the electron focussing apparatus further comprising an amplifier in operable communication with and proximal to the signal output of said electron receiving element, or an anode functioning as a signal output directly or indirectly of the electron receiving element.

Preferably, the E/B² ratio is progressively decreased from the impact surface to the electron receiving element.

Preferably, said magnetic field is configured to also focus the electron trajectories in a direction generally orthogonal to the overall direction of said trajectories.

The detector employing electron multiplication, may comprise: cathode means defining an impact surface on which particles impact, which surface has a finite probability of generating at least one electron for each impacting particle having predetermined characteristics; a plurality of electron multiplication dynode segments, including a first dynode segment, arranged in an array; and respective means for generating electrostatic and magnetic fields in a space extending from said impact surface past said dynode segments, whereby said electrons cascade and multiply successively along said array of dynode segments; wherein said first dynode segment is positioned and said means for generating said electrostatic and magnetic fields are configured to cause said electrons to deflect on average through greater than 180 degrees, before impacting the first dynode segment, whereby to focus, in at least one dimension, multiple electrons generated from any given area of said impact surface to a smaller area at said first dynode segment, the detector or detector system further comprising an amplifier in operable communication with and proximal to the signal output of the array of the electron multiplication dynodes.

Preferably, for optimal time coherence, the average deflection is through substantially or approximately a multiple of 90 degrees. In an especially convenient configuration, the average deflection is through substantially 270 degrees, which results in the greatest magnification or focussing capability for the structure.

Preferably, said dynode array is substantially coplanar. In the case of 270 degrees deflection, the result is that the direction of particle incidence on the impact surface is substantially parallel to the plane of the dynode array, an especially convenient configuration.

The dynodes may be discrete or segments of a continuous dynode formed, for example, from resistive secondary electron emissive material.

The detector may comprise: cathode means defining an impact surface on which particles impact, which surface has a finite probability of generating at least one electron for each impacting particle having predetermined characteristics; and an electron receiving element; respective means for generating electrostatic and magnetic fields in a space extending from said impact surface to said electron receiving element; wherein said electron receiving element is positioned and said means for generating said electrostatic and magnetic fields are configured to cause said electrons to deflect on average through greater than 180 degrees before impacting the electron receiving element, whereby to focus, in at least one dimension, multiple electrons generated from any given area of said impact surface to a smaller area at said dynode segment, the detector or detector system further comprising an amplifier in operable communication with and proximal to the signal output of the array of dynode segments.

Preferably, for optimal time coherence, the deflection is through substantially a multiple of 90 degrees. In an especially convenient configuration, the deflection is through substantially 270 degrees, which results in the greatest magnification or focussing capability for the structure.

The detector may include: cathode means defining an impact surface on which particles impact, which surface has a finite probability of generating at least one electron for each impacting particle having predetermined characteristics; a plurality of electron multiplication dynode segments, including a first dynode segment, arranged in an array; and respective means for generating electrostatic and magnetic fields in a space extending from said impact surface past said dynode segments, whereby said electrons cascade and multiply successively along said array of dynode segments; wherein said means for generating a magnetic field comprises at least two magnetic poles positioned with respect to said cathode means to generate a magnetic field extending in a direction generating generally orthogonal or nearly orthogonal to said electrostatic field but configured to cause focussing, in said direction, of trajectories of said electrons from said impact surface to said first dynode segment, the detector or detector system further comprising an amplifier in operable communication with and proximal to the signal output of the array of the electron multiplication dynode segments.

A magnetic field which is uniform and strictly orthogonal to the electrostatic field will result in electron focussing in only one dimension (the dimension of net migration for the electrons). Appropriate position and shape of the magnetic pole pieces can result in variations from a strictly orthogonal magnetic field direction which can further result in focussing the electrons in a second dimension (the dimension which is parallel to the nominal magnetic field direction).

The detector may include cathode means defining an impact surface on which particles impact, which surface has a finite probability of generating at least one electron for each impacting particle having predetermined characteristics; and an electron receiving element; respective means for generating electrostatic and magnetic fields in a space extending from said impact surface to said electron receiving element; wherein said means for generating a magnetic field comprises at least two magnetic poles positioned with respect to said cathode means to generate a magnetic field extending in a direction generating generally orthogonal or nearly orthogonal to said electrostatic field and configured to cause focussing, in said direction, of trajectories of said electrons from said impact surface to said electron receiving element, the electron focussing apparatus further comprising an amplifier in operable communication with and proximal to the signal output of the array of the apparatus.

The detector may include: cathode means defining an impact surface on which particles impact, which surface has a finite probability of generating at least one electron for each impacting particle having predetermined characteristics; a plurality of electron multiplication dynode segments, including a first dynode segment, arranged in an array; and respective means for generating electrostatic and magnetic fields in a space extending from said impact surface past said dynode segments, whereby said electrons cascade and multiply successively along said array of dynode segments; wherein said means for generating a magnetic field may comprise at least two magnetic poles positioned with respect to said cathode means to generate a magnetic field extending in a direction generating generally orthogonal or nearly orthogonal to said electrostatic field but configured to cause focussing, in said direction, of trajectories of said electrons from said impact surface to said first dynode segment, the detector or detector system further comprising an amplifier in operable communication with and proximal to the signal output of the array of the electron multiplication dynode segments.

The detector may include: cathode means defining an impact surface on which particles impact, which surface has a finite probability of generating at least one electron for each impacting particle having predetermined characteristics; and an electron receiving element; respective means for generating electrostatic and magnetic fields in a space extending from said impact surface to said electron receiving element; where said fields in some desired instances confine each electron between an individual pair of electrostatic potentials (voltages) whose potential difference is determined by the electron's kinetic energy; wherein such confinement allows for highly efficient transport of electrons through arbitrarily complex trajectories, the electron focussing apparatus further comprising an amplifier in operable communication with and proximal to the signal output of the array of the apparatus.

The detector may include: cathode means defining an impact surface on which particles impact, which surface has a finite probability of generating at least one electron for each impacting particle having predetermined characteristics; and an electron receiving element; respective means for generating electrostatic and magnetic fields in a space extending from said impact surface to said electron receiving element; where said fields in some desired instances confine each electron between an individual pair of electrostatic potentials (voltages) whose potential difference is determined by the electron's kinetic energy; wherein said confinement is used to modify the cross-section of the confined electron flux for various effects including focussing, the electron focussing apparatus further comprising an amplifier in operable communication with and proximal to the signal output of the array of the apparatus.

In some embodiments, the electron amplification within the detector is provided by way of a continuous dynode (also known as a channeltron or CEM) or multi-channel continuous dynode, and the output of either is in operational connection with a proximal amplifier.

Some embodiments, are not required to achieve temporal coherence. This allows for a continuous dynode or multi-channel continuous dynode to be solely operated in connection with a proximal amplifier. This may provide the aforementioned improvements in detector life.

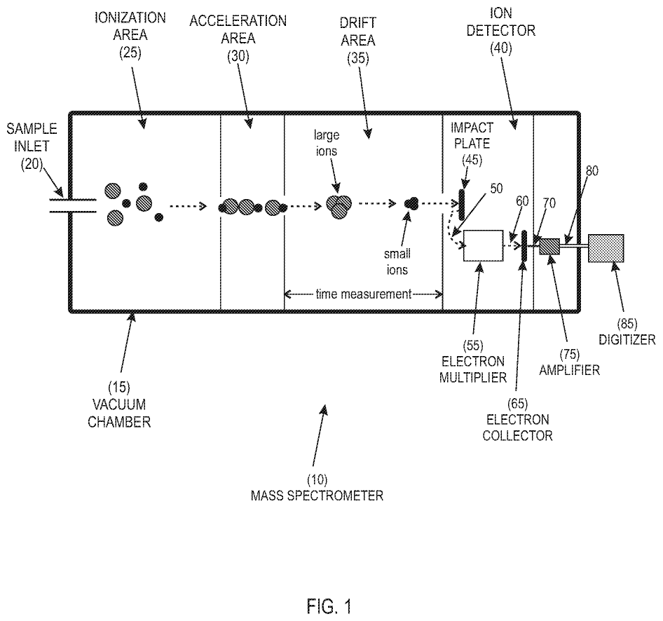

Reference is now made to the accompanying non-limiting drawings. FIG. 1 shows a preferred embodiment of the invention as applied to a linear time-of-flight mass spectrometer (10). The spectrometer (10) comprises a vacuum chamber (15) having a sample inlet port (20). After passing into the vacuum chamber (15) via the inlet port (20), sample (comprising a mixture of small and large compounds) is ionized in the ionization area (25) before moving into the acceleration are (30). The accelerated ionized compounds pass into the drift area (35) whereby per unit time the smaller compounds travel further than the larger compounds, thereby arriving at the ion detector (40) earlier.

The ions hit the impact plate (45) of the detector (40), with each impact causing the emission of one or secondary electrons. The secondary electrons are guided along the path (50) toward the electron multiplier (55) which amplifies the initial electron signal from the impact plate (45) to result in the output of an avalanche of electrons (60). The electrons (60) are collected by an electron collector (65) which is typically an anode of some description, with the current so-formed passing by wire (70) to the amplifier (75) which is proximal to the electron collector (65). The amplifier (75) output passes by wire (80) to a digitizer unit (85).

The time taken for each ionized compound to move from the start of the flight area to the detector is determined, and the size and relative amount of each compound calculated.

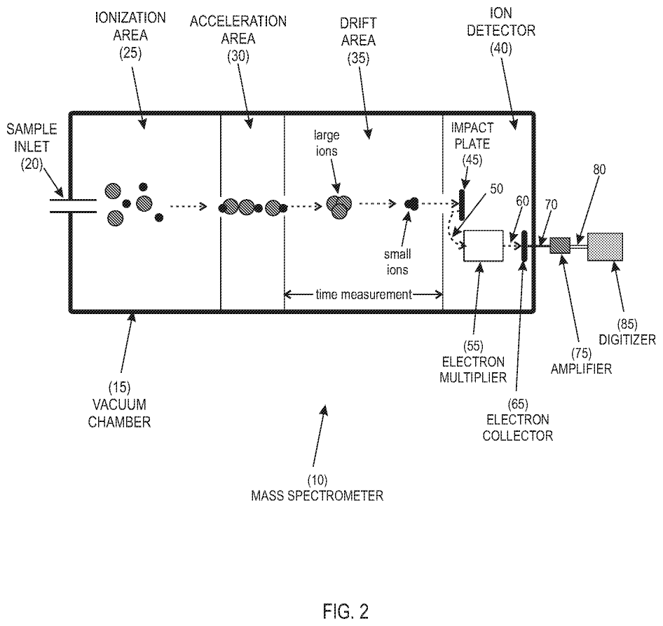

An alternative form of the embodiment illustrated in FIG. 1 is shown in FIG. 2, whereby the amplifier (75) is disposed outside the vacuum chamber (15). It will be noted that the amplifier (75) remains proximal to the electron collector (65).

It is preferred however that the amplifier is disposed within the vacuum chamber or attached to the vacuum chamber so as to maximize proximity with the detector. Furthermore, the amplifier may operate with lower noise when in a vacuum.

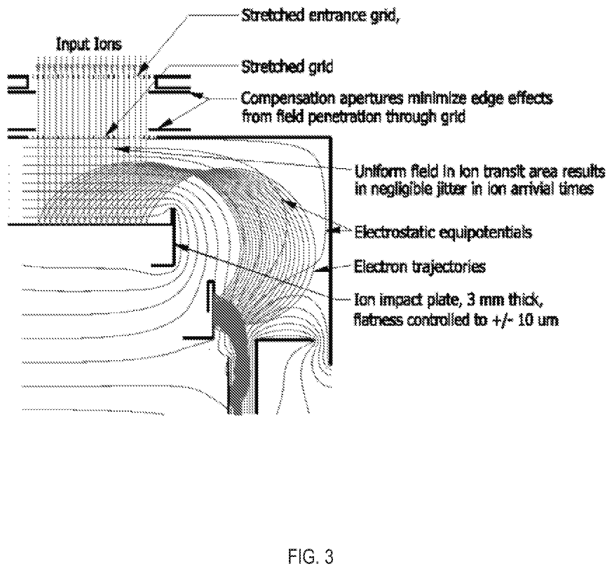

Reference is made to FIG. 3 showing structural features and electron optics for an exemplary time-of-flight detector suitable for use in the context of the present invention. The drawing shows an outer grid, which may be fixed at a user defined voltage (for example within ±5 kV of −HV), and is included in the design for ease of integration into a TOF system. The ion input grids are made from parallel wires stretched over a flat frame enabling precision control over transmission to, for example, 92%.

To take advantage of narrow pulse width it is preferred to minimize jitter and arrange for minimum disturbance to the input ions as they pass through the detector to the impact surface. To achieve this careful attention has been paid to achieving a very uniform electrostatic field in the ion transit area. The small “kick-up” at the right end of the ion impact plate is an example of the design details included to achieve this goal.

Each internal transmission grid is equipped with a compensation aperture which compensates for edge effects from field penetration through the grid.

The ion impact surface is made from about 3 mm thick stainless steel (coated with appropriate dynode materials). This allows for an unusually flat ion impact surface: ±10 μm is standard, ±5 μm or less is optional.

The grids are made from parallel wires stretched over a flat frame enabling very flat grid surfaces.

While the invention has been disclosed in connection with the preferred embodiments shown and described in detail, various modifications and improvements thereon will become readily apparent to those skilled in the art.

Accordingly, the spirit and scope of the present invention is not to be limited by the foregoing examples, but is to be understood in the broadest sense allowable by law.

1. Apparatus for detecting a particle, the apparatus comprising
a particle detector comprising:
a particle converter configured to convert an incoming ion into one or more secondary electrons upon impact thereon,
a secondary electron amplifier configured to receive and amplify the one or more secondary electrons emitted by the particle converter and output an output signal,
an output signal amplifier configured to receive and amplify the output signal of the cross-field detector, and
a digitizer configured to receive and digitize the output of the output signal amplifier,
wherein the particle detector is a cross-field detector that is operable so as to limit the amplification of an incoming particle to secondary electrons to a maximum of about 10⁷, 10⁶, 10⁵, or 10⁴ secondary electrons per incoming particle.

2. The apparatus of claim 1, wherein the particle converter and the secondary electron amplifier are an integral unit.

3. The apparatus of claim 1, wherein the cross-field detector is a time-of-flight detector and the particle converter is an ion impact plate.

4. The apparatus of claim 3, wherein the time-of-flight detector is configured to provide a pulse width of less than about 2 ns, 1.5 ns, 1 ns, 0.9 ns, 0.8 ns, 0.7 ns, 0.6 ns, 0.5 ns or 0.4 ns FWHM (full width half maximum).

5. The apparatus of claim 3, wherein the time-of-flight detector is configured to provide a highly uniform electrostatic field in the area extending from a detector input aperture through which an incoming particle is received to the ion impact plate.

6. The apparatus of claim 5, wherein the highly uniform electrostatic field is provided at least in part by paired grids, each grid having a plane orthogonal to the ion impact plate, each grid fabricated from parallel conducting wires.

7. The apparatus of claim 5, wherein the highly uniform electrostatic field is provided at least in part by a ledge extending away from the ion impact plate, the ledge being at an edge of the ion impact plate over which secondary electrons emitted by the ion impact plate travel.

8. The apparatus of claim 5, wherein the highly uniform electrostatic field is configured to reduce jitter in arrival times of particles transiting through the area extending from the detector entrance through which an incoming particle is received on the ion impact plate.

9. The apparatus of claim 3, wherein the ion impact plate has a flatness controlled to within ±10 μm, or within ±5 μm.

10. The apparatus of claim 3, wherein the ion impact plate is fabricated from approximately 3 mm thickness stainless steel coated in a dynode material.

11. The apparatus of claim 5, comprising one or more compensation apertures about the edge of the highly uniform electrostatic field to compensate for edge effects arising from field penetration through one or both of the paired grids.

12. The apparatus of claim 3, wherein the time-of-flight detector is configured to provide a non-uniform magnetic field which functions to guide electrons emitted from the particle converter toward the secondary electron multiplier.

13. The apparatus of claim 3, wherein the time-of-flight detector is a MagneTOF™ detector or a functional equivalent thereof, including model DM291 and model DM167, or a functional equivalent thereof.

14. The apparatus of claim 1, wherein the cross-field detector is, or comprises, a channel electron multiplier.

15. The apparatus of claim 1, wherein the cross-field detector is operable so as to limit the amplification of an incoming particle to a maximum of about 10³, 10², or 10¹.

16. The apparatus of claim 1, wherein the cross-field detector is operable so as to limit the amplification of an incoming particle to a maximum of about five-fold.

17. The apparatus of claim 1, wherein the amplification of the cross-field detector is settable by an operating voltage thereof.

18. The apparatus of claim 17, wherein the operating voltage is settable so as to prevent or inhibit the generation of a carbonaceous layer on a secondary electron emitting surface of the particle converter and/or the secondary electron amplifier.

19. The apparatus of claim 1, wherein the cross-field detector has an output and the output signal amplifier has an input, and the output signal amplifier input is disposed proximal to the cross-field detector output.

20. The apparatus of claim 19, wherein the output signal amplifier input is disposed at a maximum of about 100 cm, 90 cm, 80 cm, 70 cm, 60 cm, 50 cm, 40 cm, 30 cm, 20 cm or 10 cm from the cross-field detector output.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)
